(19) United States
(12) Patent Application Publication
(10) Pub. No.: US 2012/0160749 A1
(43) Pub. Date: Jun. 28, 2012

(54) FILTER GROUP FOR DIESEL-POWERED INTERNAL COMBUSTION ENGINES WITH A HEATER DEVICE

(75) Inventor: Giorgio Girondi, Mantova (IT)

(73) Assignee: UFI FILTERS S.P.A., Porto Mantovano (Mantova) (IT)

(21) Appl. No.: 13/382,279

(22) PCT Filed: Jul. 5, 2010
(86) PCT No.: PCT/EP10/59558

§ 371 Date: Mar. 6, 2012

(30) Foreign Application Priority Data
Jul. 6, 2009 (IT) RE2009A000070

(51) Int. Cl. B01D 35/18; F02M 37/22

(52) U.S. Cl. 210/149

(57) ABSTRACT

A filter group for diesel-powered internal combustion includes an external casing an internal volume of which is divided into two distinct chambers by a filter wall into which an inlet conduit and an outlet conduit for the fuel open, at least one heater being fitted internally of the casing, the at least one heater is housed inside a protection body and is connected to a control circuit, and at least one temperature sensor, the at least one temperature sensor being located externally of the protection body and being connected to the control circuit managing the heater device on a basis of a temperature registered by the sensor.

### TECHNICAL FIELD

The invention relates to a filter group for diesel-powered internal combustion engines with a heater device, and in particular for a filter group fitted with a heater device for the melting of paraffins that solidify in the fuel at low temperatures.

### BACKGROUND ART

As is known, diesel-cycle engines often have starting problems at low temperatures. This problem is due to the solidification of the paraffins in the diesel fuel. In fact solidified paraffins settle on the surface of the filter wall and prevent the filtering of the fuel through the wall.

This happens when the diesel fuel reaches a temperature that is lower than the temperature at which paraffins start forming.

To solve this problem it is common practice to install inside the filter group a resistance heater device that activates when the fuel temperature is close to or lower than the paraffination temperature, heating the diesel fuel such that the solid paraffins melt and can be filtered, without blocking, through the wall. A solution of this kind is described and shown in the European Patent EP1750824 in the name of the same applicant.

The above-cited document illustrates and describes a filter group comprising an external casing whose internal volume is divided into two distinct chambers by a filter wall into which open an inlet conduit and an outlet conduit for the fuel. A resistive heater is housed Inside the casing, which heater is connected to a command and control circuit. In particular the heater device is housed in a tubular protection body that extends into the chamber from where the inlet fuel conduit departs and exhibits a plurality of openings for the passage of the fuel. A temperature sensor is housed inside the protection body also housing the heater device, which temperature sensor is for detecting the temperature of the fuel that is contained in the filter, the signal emitted by the sensor is used to activate the heater device when the registered temperature is close to or lower than the temperature at which paraffins form. The heater switches off when the temperature registered by the sensor reaches a predetermined level.

The housing of the temperature sensor inside the protection body and in proximity of the heater device has the drawback that the fuel temperature registered by the sensor is influenced by the temperature of the heater device and is higher than the average temperature of the fuel contained in the filter. Therefore it happens that the heater device is interrupted when the entirety of the paraffins that are inside the casing have not yet melted. Under certain circumstances, this causes the above-mentioned and known engine start-up problems.

As a consequence there is a strong need for a diesel fuel filter fitted with a heater that is reliable.

The aim of the present invention is to provide a filter that exhibits structural and functional features which can satisfy this need and which at the same time obviates the problems that are related to the prior art.

### DISCLOSURE OF INVENTION

The aim is attained thanks to the filter of claim 1. In particular the invention makes available a filter group for diesel-powered internal combustion engines comprising an external casing, the internal volume of which is divided by a filter wall into two distinct chambers by a filter wall into which open an inlet conduit and an outlet conduit for the fuel.

At least a heater is located inside the casing, which is housed inside a protection body, and at least one temperature sensor, which is located externally of the protection body. Both the heater and the temperature sensor are connected to a control circuit that manages the functioning of the heater device on the basis of the temperature registered by the sensor.

The protection body in which the heater is housed is made of heat-insulating synthetic material. In a preferred form of embodiment the synthetic material is also electrically-insulating.

According to the invention the temperature sensor can be alternatively connected directly to the filter group casing or to the protection body of the heater device.

In the second instance the temperature sensor is connected to an external wall of the protection body and is preferably located in a suitable housing that can be configured as a channel on a wall of the protection body.

The dependent claims delineate particularly advantageous preferred embodiments of embodiment of the filter according to the invention.

Further characteristics and advantages of the invention will emerge from the detailed description that follows, provided by way of non-limiting example, illustrated by the figures of the accompanying tables, where FIG. 1 shows an axial section view of a filter, according to the invention.

### BRIEF DESCRIPTION OF DRAWINGS

FIG. 1 shows a filter group 1 comprising an external casing 2, beaker-shaped and superiorly-closed by a lid 3 to which an inlet conduit 4 and an outlet conduit 5 for the fuel are fitted.

### BEST MODE FOR CARRYING OUT THE INVENTION

A toroidal filter wall 7 is housed Inside the casing 1 and is inferiorly supported by an inferior base 8; at the top it is inserted into a spur 6 that derives from the lid 3.

The filter wall 7 substantially divides the inside volume of the casing 2 into two distinct chambers 9 and 10, of which the first 9 is set in communication with the inlet conduit 4 of the fuel to be filtered and the second, 10, to the outlet conduit 5 for the filtered fuel.

The casing 2 inferiorly exhibits a hole 20 in which a device 12 is received, internally of which a sensor for registering the temperature 13 and two PTC type heaters of the fuel 14 are housed, both of which are connected to a command and control circuit and supported by an electronic board 15.

The device 12 comprises a protection body 16 and a lower box 21, the function of which will be more fully described herein below.

The body 16 is shaped as a shaft that is sealedly inserted, thanks to the seals 17, 18 and 19, into the casing 2 and into the filter wall 7 and that extends almost as far as the spur 6 such as to define, together with the filter wall 7, the chambers 9 and 10.

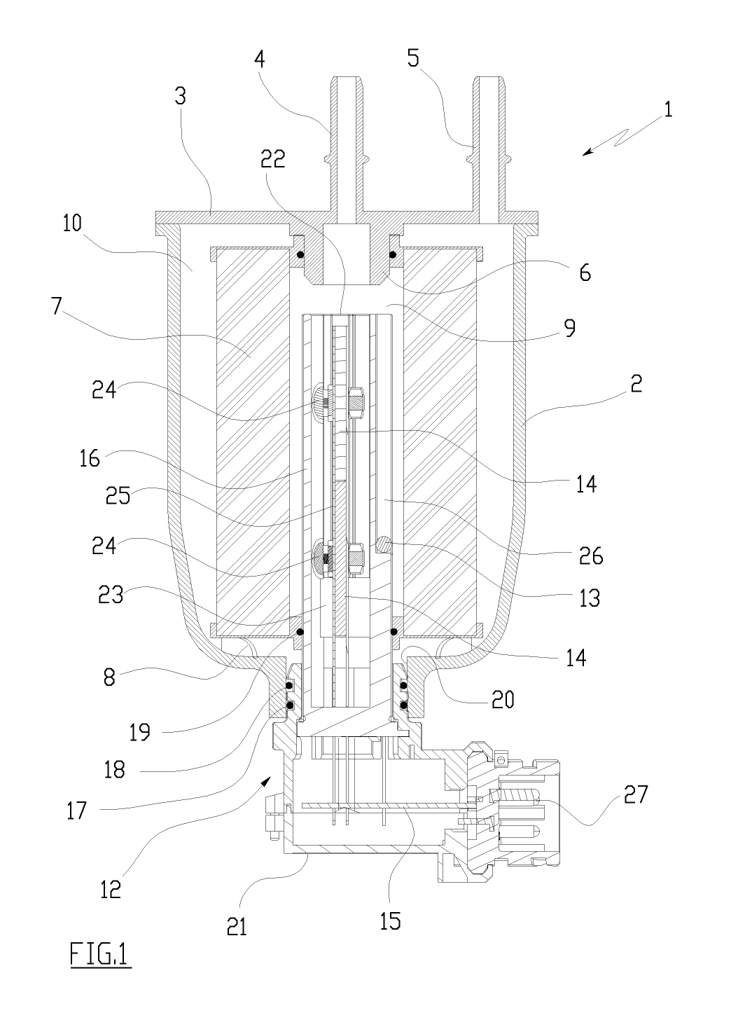

The body 16 is internally hollow and exhibits a first opening 22 on the upper end and two more openings 23, only one of which is visible in FIG. 1, on the external surface, which enable flow of the fuel internally of the body 16.

Two PTC heaters 14 are fitted inside the body 16, each of which heaters 14 is fastened by bolts 24 to the supporting walls 25 that extend inside the body 16. The supporting walls 25 made of proper conductive material, also act as electrical contacts for the PTC heaters 14.

A longitudinal channel 26 is also afforded on the external surface of the body 16, which functions as the housing for the temperature sensor 13.

The box 21 is fitted to the lower end of the body 16, which box 21 remains outside the casing 2, and internally of which box 21 the electronic board 15 is housed. The electronic board is electrically linked to a connector 27 for connecting the electronic board 15 to the control panel of the vehicle.

As previously mentioned, the electronic board 15 comprises a command and control circuit which activates the PTC heaters on the basis of the temperature values registered by the sensor 13.

The housing of the temperature sensor 13 outside the body 16, which body 16 is made of heat- and electrically-insulating synthetic material, is particularly advantageous as the registration of the temperatures of the sensor 13 is not influenced by the temperature of the two heaters 14 and is, consequently, more reliable for registering the average temperature of the fuel entering the filter. Consequently the device according to the invention obviates the problems of the devices according to the prior art.

Finally, it is worth pointing out that, in other embodiments, the device 12 can integrate heaters which are different in number and/or type from those previously shown.

1. An improved filter group for diesel-powered internal combustion engines comprising an external casing an internal volume of which is divided into two distinct chambers by a filter wall into which an inlet conduit and an outlet conduit for the fuel open, at least a heater being fitted internally of the casing, which at least a heater is housed inside a protection body and is connected to a control circuit, and at least a temperature sensor, characterized in that the at least a temperature sensor is located externally of the protection body and is connected to the control circuit managing the heater device on a basis of a temperature registered by the sensor.

2. The device of claim 1, characterized in that the protection body wherein the casing is housed is removably inserted in the casing.

3. The device of claim 2, characterized in that the casing exhibits a hole in which a portion of the protection body is housed.

4. The device of claim 1, characterized in that the circuit, connected to the at least a heater and to the at least a sensor for registering a temperature, is housed internally of a box located externally of the casing and connected at an end thereof to the protection body.

5. The device of claim 1, characterized in that the at least a heater is a PTC type heater.

6. The device of claim 1, characterized in that the sensor comprises an NTC sensor.

7. The device of claim 1, characterized in that the sensor is housed internally of the casing in a position such as to be in contact with fluid contained inside the container and such as not to be influenced by the temperature of the least a heater.

8. The device of claim 1, characterized in that the at least a sensor is associated to a wall of the casing.

9. The device of claim 1, characterized in that the at least a sensor is associated to the external surface of the protection body.

10. The device of claim 9, characterized in that the temperature sensor is housed in a channel of the external surface of the protection body.

11. The device of claim 1 or 9, characterized in that the protection body is made of a heat-insulating synthetic material.

12. The device of claim 1 or 9 characterized in that the protection body is made of a heat- and electrically-insulating synthetic material.
